(19) United States
(12) Patent Application Publication
(10) Pub. No.: US 2013/0244080 A1
(43) Pub. Date: Sep. 19, 2013

(54) SEPARATOR FOR LITHIUM SECONDARY BATTERY

(71) Applicant: SAMSUNG SDI CO., LTD., Yongin-si (KR)

(72) Inventors: Keun-Won Song, Yongin-si (KR); Duck-Chul Hwang, Yongin-si (KR); Yong-Beom Lee, Yongin-si (KR); Jeong-Ki Ha, Yongin-si (KR)

(73) Assignee: SAMSUNG SDI CO., LTD., Yongin-si (KR)

(21) Appl. No.: 13/657,583

(22) Filed: Oct. 22, 2012

Related U.S. Application Data
(60) Provisional application No. 61/611,830, filed on Mar. 16, 2012.

(51) Int. Cl. H01M 2/16; H01M 10/00

(52) U.S. Cl. 429/144; 429/247; 429/252; 29/623.1

(57) ABSTRACT

A separator for a lithium secondary battery includes a coating layer including an organic/inorganic bindable silane compound having a reactive functional group, the reactive functional group being selected from the group consisting of amino groups, isocyanate groups, epoxy groups, mercapto groups, and combinations thereof; and an inorganic compound. The separator has excellent high temperature stability.

### CROSS-REFERENCE TO RELATED APPLICATION

This application claims priority to and the benefit of U.S. Provisional Application No. 61/611,830, filed on Mar. 16, 2012, in the United States Patent and Trademark Office, the entire content of which is incorporated herein by reference.

### BACKGROUND

(a) Field

A separator for a lithium secondary battery is disclosed.

(b) Description of the Related Art

A non-aqueous lithium secondary battery typically includes a separator made of a porous insulating film and interposed between positive and negative electrodes. The pores of the film are impregnated by an electrolyte solution including a lithium salt dissolved therein. The non-aqueous lithium secondary battery has excellent initial high-capacity and high energy density characteristics. However, when the positive and negative electrodes therein are repetitively contracted and expanded during the charge and discharge cycles, they react with the separator or the electrolyte solution, and, as a result, the non-aqueous lithium secondary battery may be easily deteriorated, have internal and external short circuits, and rapidly become hot. When the battery rapidly becomes hot as aforementioned, the separator fuses and is rapidly contracted or destroyed and, thus, can be short-circuited again.

In order to prevent this problem, a separator is formed of a porous polyethylene film having excellent shutdown characteristic, easy handling, and low cost. Herein, the shutdown causes the separator to become partly fused, thereby closing pores and cutting off the current, when the battery is heated up due to overcharge, external or internal short circuit, and the like.

In addition, attempts have been made to improve safety of the non-aqueous lithium secondary battery by improving heat resistance of the electrode material, the separator, and the like, and in particular, to secure safety even when the separator is sharply contracted or destroyed.

### SUMMARY

Aspects of embodiments of the present invention are directed toward a separator being capable of improving cycle-life characteristics, strength, and high temperature stability of a lithium secondary battery.

According to an embodiment of the present invention, a separator for a lithium secondary battery includes a coating layer including an organic/inorganic bindable silane compound having a reactive functional group, the reactive functional group being selected from the group consisting of amino groups, isocyanate groups, epoxy groups, mercapto groups, and combinations thereof; and an inorganic compound.

The coating layer may include a surface coating formed on a surface of the inorganic compound by the organic/inorganic bindable silane compound.

The surface coating may be continuous or discontinuous.

The organic/inorganic bindable silane compound having the reactive functional group may be selected from the group consisting of epoxyalkylalkoxysilanes, aminoalkylalkoxysilanes, isocyanato alkylalkoxysilanes, mercapto alkylalkoxysilanes, and combinations thereof.

In one embodiment, the organic/inorganic bindable silane compound having the reactive functional group is selected from the group consisting of vinylalkylalkoxysilanes, halogenated alkylalkoxysilanes, vinylhalosilanes, alkylacyloxysilanes, and combinations thereof, the vinylalkylalkoxysilanes, halogenated alkylalkoxysilanes, vinylhalosilanes, alkylacyloxysilanes, and combinations thereof including the reactive functional group selected from the group consisting of amino groups, isocyanate groups, epoxy groups, mercapto groups, and combinations thereof.

The inorganic compound may be selected from the group consisting of SrTiO₃, SnO₂, CeO₂, MgO, NiO, CaO, ZnO, ZrO₂, Y₂O₃, Al₂O₃, TiO₂, BaTiO₃, SiO₂, and combinations thereof.

The coating layer may further include a binder selected from the group consisting of polyvinylidenefluoride (PVdF), poly(vinylidene-hexafluoropropylene) (P(VdF-HFP)), a modified PVDF with COOH, polyethyleneoxide (PEO), polyacrylonitrile (PAN), polyimide (PI), polyamic acid (PAA), polyamideimide (PAI), aramid, polyvinylacetate (PVA), polymethylmethacrylate (PMMA), polyvinylether (PVE), and combinations thereof.

The separator may further include a porous substrate selected from the group consisting of glass fiber, polyester, tetrafluoroethylene (e.g., TEFLON; TEFLON is a registered trademark of DUPONT), polyolefin, polytetrafluoroethylene (PTFE), and combinations thereof.

The coating layer may be formed on one side or both sides of the porous substrate.

The coating layer of the separator may include about 1 part by weight to about 20 parts by weight of the organic/inorganic bindable silane compound having the reactive functional group based on 100 parts by weight of the inorganic compound.

The coating layer of the separator may include the inorganic compound and the binder in a weight ratio in a range of about 1:0.5 to about 1:5.

The organic/inorganic bindable silane compound having the reactive functional group may be selected from the group consisting of 3-glycidoxypropyltrimethoxysilane, 3-glycidoxypropyltriethoxysilane, 2-(3,4-epoxycyclohexyl)ethyltrimethoxysilane, 3-glycidoxypropylmethyldiethoxysilane, (3-trimethoxysilylpropyl)diethylenetriamine, (2-aminoethyl)-3-aminopropyltrimethoxysilane, N-methylaminopropyltrimethoxysilane, 3-(triethoxysilyl)propyl isocyanate, 3-(trimethoxysilyl)propyl isocyanate, 3-mercaptopropyltrimethoxysilane, bis(3-(triethoxysilyl)propyl)-tetrasulfide, vinyltris (2-methoxy ethoxy) silane, 3-methacryloxylpropyltrimethoxysilane, 3-chloropropyltrimethoxysilane, vinyltrichlorosilane, methyltriacetoxysilane, and combinations thereof.

In one embodiment of the present invention, a rechargeable battery includes a positive electrode; a negative electrode; and the separator according to any of the above between the positive electrode and the negative electrode.

According to another embodiment of the present invention, a method of forming a rechargeable battery includes: forming the separator according to any of the above, a positive electrode, and a negative electrode into an electrode assembly; and providing an electrolyte to the electrode assembly.

According to aspects of embodiments of the present invention, a lithium secondary battery including the separator according to any of the above may have excellent cycle-life characteristic, strength, and high temperature stability.

### BRIEF DESCRIPTION OF THE DRAWING

The accompanying drawings, together with the specification, illustrate exemplary embodiments of the present invention, and, together with the description, serves to explain the principles of the present invention.

Here, FIG. 1 is a schematic view showing a lithium secondary battery including a separator according to one embodiment of the present invention.

FIG. 2 is a graph showing the changes in the cell capacity and the cell thickness in charge/discharge cycle tests for the lithium secondary battery including a separator of Example 1 and for the lithium secondary battery including a separator of Comparative Example.

FIG. 3 is a graph showing the AC IR changes in charge/discharge cycle tests for the lithium secondary battery including a separator of Example 1 and for the lithium secondary battery including a separator of Comparative Example.

FIG. 4 is a graph showing the results of the penetration tests for the batteries including the separator of Comparative Example.

FIG. 5 is a set of photographic images of the batteries including the separator of Comparative Example after the penetration tests.

FIG. 6 is a graph showing the results of the penetration tests for the batteries including the separator of Example 1.

FIG. 7 is a set of photographic images of the batteries including the separator of Example 1 after the penetration tests.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Also, in the context of the present application, when a first element is referred to as being “on” a second element, it can be directly on the second element or be indirectly on the second element with one or more intervening elements interposed therebetween. Like reference numerals designate like elements throughout the specification.

According to one embodiment of the present invention, a separator for a lithium secondary battery includes a coating layer including an organic/inorganic bindable silane compound having a reactive functional group, the reactive functional group being selected from the group consisting of amino groups, isocyanate groups, epoxy groups, mercapto groups, and combinations thereof; and an inorganic compound. For example, the organic/inorganic bindable silane compound may be an organofunctional silane compound having the reactive functional group.

The separator may improve heat resistance by including the inorganic compound, and concurrently (e.g., simultaneously) the heat resistance is enhanced by including the organic/inorganic bindable silane compound having a reactive functional group. The organic/inorganic bindable silane compound may provide more adherence to an electrode contacting the separator.

According to an embodiment, the inorganic compound may be coated with the organic/inorganic bindable silane compound having a reactive functional group. The organic/inorganic bindable silane compound and the inorganic compound may react to form a chemical bond, and thus, the organic/inorganic bindable silane compound may coat the surface of the inorganic compound to form a surface coating on the inorganic compound. The surface coating on the inorganic compound that is formed by the organic/inorganic bindable silane compound may be continuous or discontinuous (e.g., a continuous layer or a discontinuous layer).

The inorganic compound whose surface is treated with the organic/inorganic bindable silane compound as described above is dispersed well in an organic solvent during a preparation of a slurry because the surface of the inorganic material is treated with an organic material (e.g., the organic/inorganic bindable silane compound), thereby preventing the inorganic compound from being agglomerated (or reducing the agglomeration of the inorganic compound). To form the coating layer of the separator, a coating composition may be formed, for example, by mixing the organic/inorganic bindable silane compound and the inorganic compound with a binder and an organic solvent. The coating layer is formed by applying the coating composition to a substrate. Herein, since the surface of the inorganic compound is treated with the organic/inorganic bindable silane compound in the coating composition, coating processibility of the coating composition, such as solution preparation stability and coating speed, may be greatly improved. Also, since the coating layer formed from the coating composition has uniform coating surface and the inorganic compound is not agglomerated, when it is applied to the manufacturing of a battery, lithium precipitation and/or deformation may be prevented or reduced.

Also, the coating layer including the inorganic compound whose surface is treated with an organic/inorganic bindable silane compound has increased adhesion among the inorganic compound and, thus, thermal stability is improved. Also, since the coating layer may further include a binder as described above in the preparation of the coating composition, and the inorganic compound whose surface is treated with the organic/inorganic bindable silane compound may form a chemical bond with the binder, adhesion may be enhanced.

The inorganic compound may be selected from the group consisting of SrTiO₃, SnO₂, CeO₂, MgO, NiO, CaO, ZnO, ZrO₂, Y₂O₃, Al₂O₃, TiO₂, BaTiO₃, SiO₂, and combinations thereof.

The reactive functional group of the organic/inorganic bindable silane compound may be selected from the group consisting of amino groups, isocyanate groups, epoxy groups, mercapto groups, and combinations thereof, but it is not limited thereto.

The organic/inorganic bindable silane compound having a reactive functional group may be selected from the group consisting of, for example, epoxyalkylalkoxysilane, such as 3-g lycidoxypropyltrimethoxysilane, 3-glycidoxypropyltriethoxysilane, 2-(3,4-epoxycyclohexyl)ethyltrimethoxysilane, 3-glycidoxypropylmethyldiethoxysilane, and the like; aminoalkylalkoxysilane, such as 3-aminopropyltriethoxysilane, (3-trimethoxysilylpropyl)diethylenetriamine, (2-aminoethyl)-3-aminopropyltrimethoxysilane, N-methylaminopropyltrimethoxysilane, and the like; isocyanato alkylalkoxysilane, such as 3-(triethoxysilyl)propyl isocyanate, 3-(trimethoxysilyl)propyl isocyanate, and the like; mercapto alkylalkoxysilane, such as 3-mercaptopropyltrimethoxysilane, bis(3-(triethoxysilyl)propyl)-tetrasulfide, and the like; and combinations thereof, but it is not limited thereto.

The organic/inorganic bindable silane compound having the reactive functional group also may be an organic/inorganic bindable silane compound selected from the group consisting of vinylalkylalkoxysilane, such as vinyltris (2-methoxy ethoxy)silane, 3-methacryloxylpropyltrimethoxysilane, and the like; halogenated alkylalkoxysilane, such as 3-chloropropyltrimethoxysilane, and the like; vinylhalosilane, such as vinyltrichlorosilane, and the like; alkylacyloxysilane, such as methyltriacetoxysilane, and the like; and combinations thereof. The vinylalkylalkoxysilanes, halogenated alkylalkoxysilanes, vinylhalosilanes, alkylacyloxysilanes, and combinations thereof include the reactive functional group selected from the group consisting of amino groups, isocyanate groups, epoxy groups, mercapto groups, and combinations thereof.

The inorganic compound may be in the form of particles, and the inorganic compound may be mixed with a binder to form a coating layer. The coating layer may be formed through a general method of, for example, preparing a resin composition solution including the inorganic compound and a binder and coating at least one side of the separator substrate with the resin composition solution. The inorganic compound particles may have, for example, an average particle diameter in a range of about 0.05 to about 2 μm.

The binder may enhance the adherence of an electrode contacting a separator including the binder.

The binder may include, for example, polyvinylidenefluoride (PVdF), poly(vinylidene-hexafluoropropylene) (P(VdF-HFP)), a modified PVDF with COOH, polyethyleneoxide (PEO), polyacrylonitrile (PAN), polyimide (P1), polyamic acid (PAA), polyamideimide (PAI), aramid, polyvinylacetate (PVA), polymethylmethacrylate (PMMA), polyvinylether (PVE), and combinations thereof, but it is not limited thereto.

The coating layer of the separator may include the inorganic compound and the binder in a weight ratio in a range of about 1:0.5 to about 1:5. The coating layer of the separator includes an inorganic compound and the binder within the ratio range and, thus, increases heat resistance of the separator due to the inorganic compound and is more uniform, thereby accomplishing improved battery safety.

The coating layer of the separator may include about 1 to about 20 parts by weight of the organic/inorganic bindable silane compound having the reactive functional group based on 100 parts by weight of the inorganic compound. In one embodiment, when the coating layer of the separator includes the organic/inorganic bindable silane compound having the reactive functional group within the composition ratio range, a side reaction or unreacted reactants caused by excessive addition of the silane compound is reduced while enhancing the adhesiveness inside the coating layer obtained by coating the surface of the inorganic compound with the organic/inorganic bindable silane compound.

A thickness of the coating layer contributes to the thickness of the separator and, thus, may be adjusted depending on the desired thickness of the separator. A thinner separator may decrease cell resistance and increase capacity but deteriorate safety. Accordingly, the coating layer may have a thickness appropriately adjusted depending on a desired purpose, for example, a thickness in a range of about 0.5 μm to about 5 μm.

The separator may have a thickness determined depending on desired capacity of a battery. For example, the separator may have a thickness in a range of about 10 to about 30 μm.

The separator may include a porous substrate selected from the group consisting of glass fiber, polyester, tetrafluoroethylene (e.g., TEFLON; TEFLON is a registered trademark of DUPONT), polyolefin, polytetrafluoroethylene (PTFE), and combinations thereof. For example, the substrate may include polyolefin such as polyethylene, polypropylene, and the like and may be formed of more than two layers, for example, a multilayer such as a polyethylene/polypropylene separator, a polyethylene/polypropylene/polyethylene separator, a polypropylene/polyethylene/polypropylene separator, and the like. The separator may provide excellent heat resistance, even when a single layer, rather than a relatively thick multilayered substrate, which may reduce battery capacity, is used.

The coating layer of the separator may be on one side or both sides of the porous substrate. For example, when the coating layer of the separator is on one side of the porous substrate, the coating layer may contact with a positive electrode or a negative electrode.

After a lithium secondary battery is manufactured by providing (e.g., inserting) the separator including the coating layer between the positive electrode and the negative electrode, a network of the inorganic compound may be formed by providing (e.g., implanting) an electrolyte solution and performing a heat treatment to cause a reaction between the reactive functional group. The heat treatment may be, for example, performed through heat press. The heat treatment may be performed at a temperature in a range of about 80° C. to about 110° C. for a time period in a range of about 30 seconds to about 150 seconds with a force in a range of about 100 Kgf to about 300 Kgf. Adherence between the separator and the electrodes may be improved by applying pressure during the heat treatment.

The lithium secondary battery may be classified into lithium ion batteries, lithium ion polymer batteries, or lithium polymer batteries according to the presence of a separator and the kind of electrolyte used in the battery. The lithium secondary batteries may have a variety of shapes and sizes and thus, include cylindrical, prismatic, or coin-type batteries and also, may be thin film batteries or rather bulky batteries in size. Structures and fabrication methods for lithium secondary batteries are well known in the art.

FIG. 1 is an exploded perspective view showing a lithium secondary battery 100 including a separator 113 in accordance with an embodiment. Referring to FIG. 1, the lithium secondary battery 100 is a cylindrical battery that includes a negative electrode 112, a positive electrode 114, the separator 113 disposed between the positive electrode 114 and the negative electrode 112, an electrolyte impregnated in the negative electrode 112, the positive electrode 114, and the separator 113, a battery case 120, and a sealing member 140 sealing the battery case 120. The lithium secondary battery 100 is fabricated by sequentially stacking the negative electrode 112, the positive electrode 114, and the separator 113, and spiral-winding them and housing the wound product in the battery case 120.

In one embodiment, a negative electrode includes a current collector and a negative active material layer on the current collector, and the negative active material layer includes a negative active material and a binder.

The negative active material includes a material that reversibly intercalates/deintercalates lithium ions, a lithium metal, a lithium metal alloy, a material being capable of doping lithium, or a transition metal oxide.

The material that reversibly intercalates/deintercalates lithium ions includes, for example, carbon materials. The carbon material may be any generally-used carbon-based negative active material in a lithium ion secondary battery. Examples of the carbon material include crystalline carbon, amorphous carbon, and a combination thereof. The crystalline carbon may be non-shaped, or sheet, flake, spherical, or fiber shaped natural graphite or artificial graphite. The amorphous carbon may be a soft carbon (carbon obtained by sintering at a low temperature), a hard carbon (carbon obtained by sintering at a high temperature), mesophase pitch carbonized product, fired coke, and the like.

Examples of the lithium metal alloy include lithium and a metal selected from Na, K, Rb, Cs, Fr, Be, Mg, Ca, Sr, Si, Sb, Pb, In, Zn, Ba, Ra, Ge, Al, and Sn.

Examples of the material being capable of doping and dedoping lithium include Si, SiOₓ(0<x<2), a Si-C composite, a Si-Q alloy (wherein Q is an alkali metal, an alkaline-earth metal, Group 13 to 16 elements, a transition element, a rare earth element, or a combination thereof, and not Si), Sn, SnO₂, a Sn—C composite, a Sn—R alloy (wherein R is an alkali metal, an alkaline-earth metal, Group 13 to 16 elements, a transition element, a rare earth element, or a combination thereof and is not Sn), and the like. For example, the Q and R may each be an element of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

Examples of the transition metal oxide include vanadium oxide, lithium vanadium oxide, and the like.

The negative active material layer may include a binder, and optionally a conductive material.

The binder improves binding properties of the negative active material particles to each other and to a current collector, and may include polyvinylalcohol, carboxylmethylcellulose, hydroxypropylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but it is not limited thereto.

The conductive material improves electrical conductivity of a negative electrode. Any electrically conductive material can be used as a conductive agent unless it causes a chemical change. Examples of the conductive material include a carbon-based material, such as natural graphite, artificial graphite, carbon black, acetylene black, ketjen black, a carbon fiber, and the like; a metal-based material of a metal powder or a metal fiber including copper, nickel, aluminum, silver, and the like; a conductive polymer, such as a polyphenylene derivative; or a mixture thereof.

The current collector may be a copper foil, a nickel foil, a stainless steel foil, a titanium foil, a nickel foam, a copper foam, a polymer substrate coated with a conductive metal, or a combination thereof.

The positive electrode includes a current collector and a positive active material layer on the current collector.

The positive active material includes compounds (lithiated intercalation compounds) that reversibly intercalate and deintercalate lithium ions. The positive active material may include a composite oxide including at least one selected from the group consisting of cobalt, manganese, and nickel, as well as lithium. In particular, the following lithium-containing compounds may be used:

LiₐA_{1-b}R_{b}D₂ (wherein, in the above formula, 0.90≦a≦1.8 and 0≦b≦0.5); LiₐE_{1-b}R_{b}O_{2-c}D_{c} (wherein, in the above formula, 0.90≦a≦1.8, 0≦b≦0.5 and 0≦c≦0.05); LiE_{2-b}R_{b}O_{4-c}D_{c} (wherein, in the above formula, 0≦b≦0.5, 0≦c≦0.05); LiₐNi_{1-b-c}Co_{b}R_{c}D_{α} (wherein, in the above formula, 0.90≦a≦1.8, 0≦b≦0.5, 0≦c≦0.05 and 0<α≦2); LiₐNi_{1-b-c}Co_{b}R_{c}O_{2-α}Z_{α} (wherein, in the above formula, 0.90≦a≦1.8, 0≦b≦0.5, 0≦c≦0.05 and 0<α<2); LiₐNi_{1-b-c}Co_{b}R_{c}O_{2-α}Z₂ (wherein, in the above formula, 0.90≦a≦1.8, 0≦b≦0.5, 0≦c≦0.05 and 0<α<2); LiₐNi_{1-b-c}Mn_{b}R_{c}D _{α} (wherein, in the above formula, 0.90≦a≦1.8, 0≦b≦0.5, 0≦c≦0.05 and 0<α<2); LiₐNi_{1-b-c}Mn_{b}R_{c}O_{2-α}Z_{α} (wherein, in the above formula, 0.90≦a≦1.8, 0≦b≦0.5, 0≦c≦0.05 and 0 21 α<2); LiₐNi_{1-b-c}Mn_{b}R_{c}O_{2-α}Z₂ (wherein, in the above formula, 0.90≦a≦1.8, 0≦b≦0.5, 0≦c≦0.05 and 0<α<2); LiₐNi_{b}E_{c}G_{d}O₂ (wherein, in the above formula, 0.90≦a≦1.8, 0≦b≦0.9, 0≦c≦0.5 and 0.001≦d≦0.1); LiₐNi_{b}Co_{c}Mn_{d}GeO₂ (wherein, in the above formula, 0.90≦a≦1.8, 0≦b≦0.9, 0≦c≦0.5, 0≦d≦0.5 and 0.001≦e≦0.1); LiₐNiG_{b}O₂ (wherein, in the above formula, 0.90≦a≦1.8 and 0.001≦b≦0.1); LiₐCoG_{b}O₂ (wherein, in the above formula, 0.90≦a≦1.8 and 0.001≦b≦0.1); LiₐMnG_{b}O₂ (wherein, in the above formula, 0.90≦a≦1.8 and 0.001≦b≦0.1); LiₐMn₂G_{b}O₄ (wherein, in the above formula, 0.90≦a≦1.8 and 0.001≦b≦0.1); QO₂; QS₂; LiQS₂; V₂O₅; LiV₂O₅; LiTO₂; LiNiVO₄; Li_{(3-f)}J₂(PO₄)₃(0≦f≦2); Li_{(3-f)}Fe₂(PO₄)₃(0≦f≦2); and LiFePO₄.

In the above chemical formulae, A is Ni, Co, Mn, or a combination thereof; R is Al, Ni, Co, Mn, Cr, Fe, Mg, Sr, V, a rare earth element, or a combination thereof; D is O, F, S, P, or a combination thereof; E is Co, Mn, or a combination thereof; Z is F, S, P, or a combination thereof; G is Al, Cr, Mn, Fe, Mg, La, Ce, Sr, V, or a combination thereof; Q is Ti, Mo, Mn, or a combination thereof; T is Cr, V, Fe, Sc, Y, or a combination thereof; and J is V, Cr, Mn, Co, Ni, Cu, or a combination thereof.

The compound can have a coating layer on the surface, or can be mixed with a compound having a coating layer. The coating layer may include at least one coating element compound selected from the group consisting of an oxide of the coating element, a hydroxide of the coating element, an oxyhydroxide of the coating element, an oxycarbonate of the coating element, and a hydroxyl carbonate of the coating element. The compounds for a coating layer can be amorphous or crystalline. The coating element for a coating layer may include Mg, Al, Co, K, Na, Ca, Si, Ti, V, Sn, Ge, Ga, B, As, Zr, or a mixture thereof. The coating layer can be formed in a method having little or no negative influence on the properties of a positive active material by including these elements in the compound. For example, the method may include any suitable coating method, such as spray coating, dipping, and the like, but it is not illustrated in more detail, since it is well-known to those who work in the related field.

The positive active material layer may include a binder and a conductive material.

The binder improves binding properties of the positive active material particles to each other and to a current collector. Examples of the binder may include polyvinylalcohol, carboxylmethylcellulose, hydroxypropylcellulose, diacetylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, styrene-butadiene rubber, an acrylated styrene-butadiene rubber, an epoxy resin, nylon, and the like, but are not limited thereto.

The conductive material improves electrical conductivity of the positive electrode. Any electrically conductive material can be used as a conductive agent unless it causes a chemical change. For example, it may include natural graphite, artificial graphite, carbon black, acetylene black, ketjen black, carbon fiber, metal powder, metal fiber or the like, such as copper, nickel, aluminum, silver or the like, or one or at least one kind mixture of conductive material such as polyphenylene derivative or the like.

The current collector may be Al, but it is not limited thereto.

The negative and positive electrodes may be fabricated by a method including mixing the active material, a conductive material, and a binder into an active material composition, and coating the composition on a current collector, respectively. The electrode-manufacturing method is well known, and thus it is not described in detail in the present specification. The solvent may include N-methylpyrrolidone and the like, but it is not limited thereto.

The electrolyte includes a non-aqueous organic solvent and a lithium salt.

The non-aqueous organic solvent serves as a medium for transmitting ions taking part in the electrochemical reaction of the battery.

The non-aqueous organic solvent may include a carbonate-based, ester-based, ether-based, ketone-based, alcohol-based, or aprotic solvent. Examples of the carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylmethyl carbonate (EMC), ethylene carbonate (EC), propylene carbonate (PC), butylene carbonate (BC), or the like. Examples of the ester-based solvent may include methyl acetate, ethyl acetate, n-propyl acetate, 1,1-dimethylethyl acetate, methylpropionate, ethylpropionate, γ-butyrolactone, decanolide, valerolactone, mevalonolactone, caprolactone, and the like. Examples of the ether-based solvent include dibutyl ether, tetraglyme, diglyme, dimethoxyethane, 2-methyltetrahydrofuran, tetrahydrofuran, and the like, and examples of the ketone-based solvent include cyclohexanone, or the like. Examples of the alcohol-based solvent include ethyl alcohol, isopropyl alcohol, and the like, and examples of the aprotic solvent include nitriles such, as R—CN (wherein R is a C2 to C20 linear, branched, or cyclic hydrocarbon group including a double bond, an aromatic ring, or an ether bond), amides, such as dimethylformamide, dioxolanes, such as 1,3-dioxolane, sulfolanes, or the like.

The non-aqueous organic solvent may be used singularly or in a mixture. When the organic solvent is used in a mixture, the mixture ratio may be controlled in accordance with a desirable battery performance, which may be understood by the person skilled in the related art.

In an embodiment, the carbonate-based solvent is prepared by mixing a cyclic carbonate and a linear carbonate. The cyclic carbonate and the linear carbonate are mixed together in the volume ratio of about 1:1 to about 1:9. Within this range, performance of the electrolyte may be improved.

The non-aqueous organic electrolyte may be further prepared by mixing a carbonate-based solvent with an aromatic hydrocarbon-based solvent. The carbonate-based and the aromatic hydrocarbon-based solvents may be mixed together in a volume ratio in a range of about 1:1 to about 30:1.

The aromatic hydrocarbon-based organic solvent may be represented by the following Chemical Formula 1.

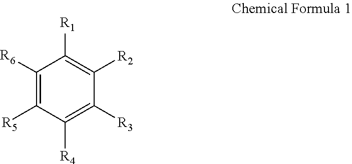

In Chemical Formula 1, R₁ to R₆ are each independently hydrogen, a halogen, a C1 to C10 alkyl group, a C1 to C10 haloalkyl group, or a combination thereof.

The aromatic hydrocarbon-based organic solvent may include benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, or a combination thereof.

The non-aqueous electrolyte may further include vinylene carbonate, an ethylene carbonate-based compound represented by the following Chemical Formula 2, or a combination thereof to improve cycle-life.

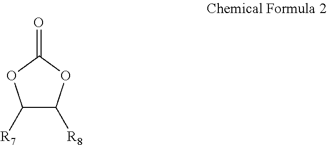

In Chemical Formula 2, R₇ and R₈ are independently selected from hydrogen, a halogen, a cyano group (CN), a nitro group (NO₂), and a C1 to C5 fluoroalkyl group, provided that at least one of R₇ and R₈ is selected from a halogen, a cyano group (CN), a nitro group (NO₂), and a C1 to C5 fluoroalkyl group.

Examples of the ethylene carbonate-based compound include difluoro ethylenecarbonate, chloroethylene carbonate, dichloroethylene carbonate, bromoethylene carbonate, dibromoethylene carbonate, nitroethylene carbonate, cyanoethylene carbonate, fluoroethylene carbonate, and the like. The amount of the vinylene carbonate or the ethylene carbonate-based compound used to improve cycle life may be adjusted within an appropriate range.

The lithium salt, which is dissolved in an organic solvent, supplies a battery with lithium ions, operates a basic operation of the lithium secondary battery, and improves lithium ion transportation between positive and negative electrodes therein. Examples of the lithium salt include LiPF₆, LiBF₄, LiSbF₆, LiAsF₆, LiC₄F₉SO₃, LiClO₄, LiAlO₂, LiAlCl₄, LiN(CₓF₂ₓ₊₁SO₂)(C_{y}F_{2y+1}SO₂) (where x and y are natural numbers), LiCl, Lil, LiB(C₂O₄)₂ (lithium bis(oxalato) borate, LiBOB), or a combination thereof, as a supporting electrolytic salt. The lithium salt may be used in a concentration in a range of about 0.1 M to about 2.0 M. When the lithium salt is included at the above concentration range, an electrolyte may have excellent performance and lithium ion mobility due to enhanced electrolyte conductivity and viscosity.

The separator 113 separates the negative electrode 112 from the positive electrode 114 and provides passages (e.g., a transporting passage) for lithium ions.

The following examples illustrate the present invention in more detail. These examples, however, should not be interpreted as limiting the scope of the present invention.

### EXAMPLE

(Manufacturing of Separator Including Coating Layer)

### Examples 1 to 6

25 g of alumina is added to 75 g of acetone followed by agitating. Then, 2.5 g of an additive provided in the following Table 1 is added to the mixture of 75 g of acetone and 25g of alumina, and the resulting mixture is agitated (solution 1). The additive reacts with alumina during the agitation and coated on the surface of the alumina.

A polymer solution is prepared by adding 5 g of a binder as set forth in the following Table 1 to 45 g of acetone and agitating them (solution 2).

The solutions 1 and 2 are mixed and agitated (solution 3).

The solution 3 is coated on both sides of a 9 μm-thick polyethylene (PE) separator. The coating layers are respectively 2 μm thick.

TABLE 1

| Example | additive | binder |
|---|---|---|
| 1 | 3-aminopropyltriethoxysilane | poly(vinylidene-hexafluoropropylene) |
| | | (hereinafter, (PVDF-HFP)) |
| 2 | 3-glycidoxypropyltriethoxysilane | (PVDF-HFP) |
| 3 | 3-(triethoxysilyl)propyl isocyanate) | (PVDF-HFP) |
| 4 | 3-aminopropyltriethoxysilane | PVDF + (a modified PVDF with COOH) |
| 5 | 3-glycidoxypropyltriethoxysilane | PVDF + (a modified PVDF with COOH) |
| 6 | 3-aminopropyltriethoxysilane | PVDF + (a modified PVDF with COOH) |

### Fabrication of Electrode

(Positive electrode) LiCoO₂ as a positive active material, a PVDF-based binder, and Super-P as a conductive material in a mass ratio of 94/3/3 are mixed in NMP(N-methyl-2-pyrrolidone) as a solvent to prepare a slurry, and the slurry is coated on a 12 μm-thick aluminum current collector. The coated product is dried and compressed, fabricating a positive electrode.

The PVDF-based binder is prepared by mixing a binder including only a PVDF component (binder) and a PVDF-based binder including a COOH component.

(Negative electrode) Graphite as a negative active material, a styrene-butadiene rubber (SBR) as a binder, and CMC (carboxylmethyl cellulose) in a mass ratio of 98/1/1 are mixed in water as a solvent to prepare a slurry, and the slurry is coated on a 12 μm-thick copper current collector.

The coated product is dried and compressed, fabricating a negative electrode like the positive electrode.

The positive electrodes, the negative electrodes, and the separators according to Examples 1 to 3 are used to fabricate pouch-type battery cells 423380, respectively. Herein, an electrolyte solution is prepared by mixing EC (ethyl carbonate)/EMC (ethylmethyl carbonate)/DEC (diethyl carbonate) in a volume ratio of 3/5/2 and dissolving 1.3M LiPF₆ therein.

The electrolyte solution is injected into the cells, and the cells are pressed with a force of 200 Kgf at 100° C. for 100 seconds.

### COMPARATIVE EXAMPLE

A separator is prepared in the same manner as set forth in Example 1 except that no additive is included therein.

### Experimental Example 1

### Measurement of Cell Capacity and a Thickness Change with an Increase in the Number of Cycles During a High Temperature Life Cycle test at 45° C.

A battery is fabricated using a separator of Example 1, and positive and negative electrodes prepared as above, and is denoted as Coupling NEO. For comparison, a battery is also fabricated using a separator of Comparative Example, and positive and negative electrodes prepared as above, and is denoted as NEO V2. These two batteries are subjected to a charge/discharge cycle test under the following conditions to measure changes in cell capacity and a thickness change thereof:
Charge: 0.7 C, 4.3V
Discharge: 0.5 C, 3.0V cut off
Rest time: 5 minutes

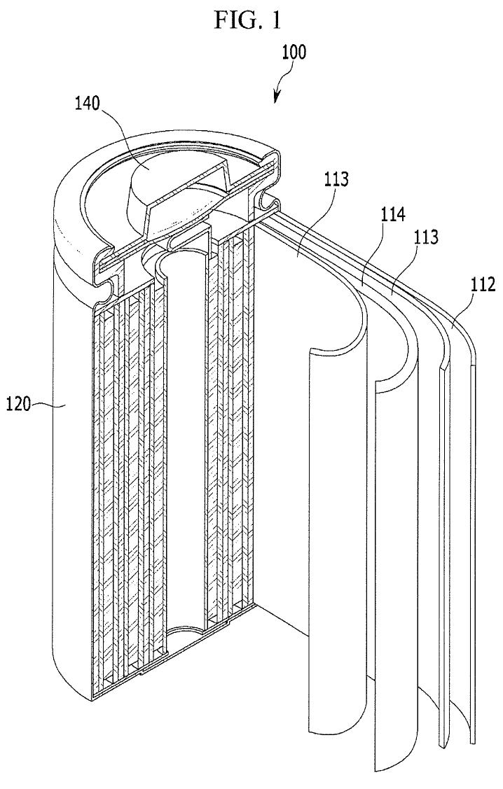

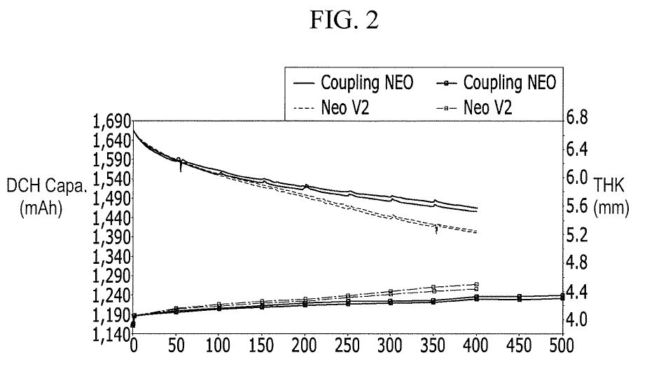

The results are shown in FIG. 2. As can be seen in FIG. 2, the battery, Coupling Neo, using the separator of Example 1, which comprises aminopropyl triethoxy silane as an additive, shows a smaller increase in its thickness and a higher capacity maintenance ratio than the battery, NEO V2, using the separator of Comparative Example.

In case of the battery of the present invention, the organic/inorganic bindable silane compound being included in the separator may react with the binder of the electrode, thereby contributing to an increase in adhesiveness between the electrode and the separator. In addition, when the organic/inorganic bindable silane compound reacts with the binder being used in the separator, it may contribute to increasing a molecular weight of binder polymer, thereby enhancing the adhesiveness of the binder itself. As a result, the gap between the electrode and the separator may decrease and, this may reduce chance for side reactions to occur in such gap and thereby prolong the battery life.

### Experimental Example 2

### Measurement of an AC IR Change in a Battery Cycle Test

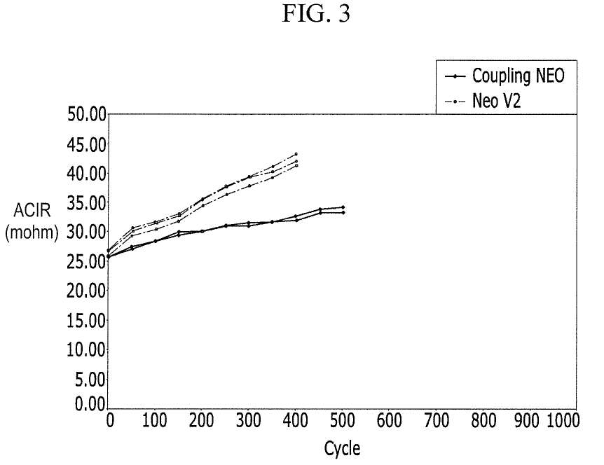

The increase rate of internal resistance of the battery is measured when the charge/discharge cycle test as described above for the batteries is carried out. The results are shown in FIG. 3. FIG. 3 confirms that as the number of charge/discharge cycles increases, the battery, Coupling NEO has a lower value of the increase rate of internal resistance of the battery than the battery of Comparative Example, NEO V2.

### Experimental Example 3

### Penetration Test

A penetration test is conducted for the battery comprising the separator of Example 1 and the battery comprising the separator of Comparative Example, respectively. Conditions for penetration test are as follows: the battery is fully charged at 0.7 C and 4.3V, and is left alone for 30 minutes. Then, an iron bar having a diameter of 2.5 mm penetrates into the battery at a speed of 100 mm/s many times, and the voltage, the temperature, and the ignition of the battery are checked.

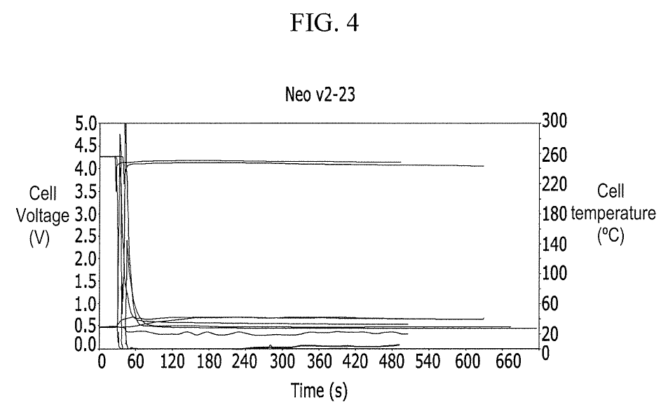

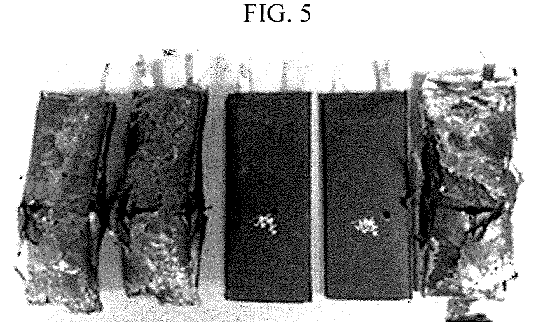

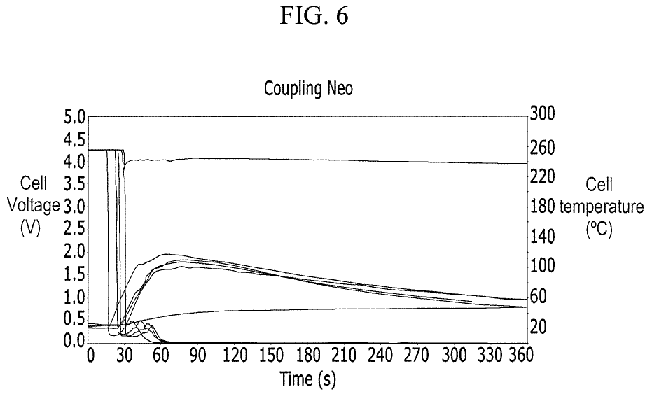

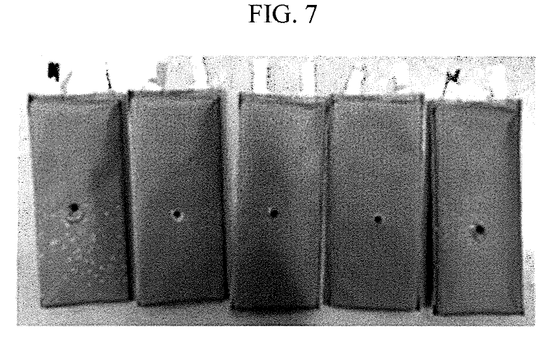

The test results for the battery of Comparative Example are shown in FIG. 4 and FIG. 5, showing that the penetration of the iron bar may cause a sharp and sudden increase in the battery temperature, leading to ignition of the battery of Comparative Example. By contrast, the test results for the battery of Example 1 are shown in FIG. 6 and FIG. 7, showing that it passes the penetration test without being ignited.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims, and equivalents thereof.

### DESCRIPTION OF SYMBOLS

| | |
|---|---|
| 100: lithium secondary battery | 112: negative electrode |
| 113: separator | 114: positive electrode |
| 120: battery case | 140: sealing member |

What is claimed is:

1. A separator for a lithium secondary battery, the separator comprising:
a coating layer comprising:
an organic/inorganic bindable silane compound having a reactive functional group, the reactive functional group being selected from the group consisting of amino groups, isocyanate groups, epoxy groups, mercapto groups, and combinations thereof; and
an inorganic compound.

2. The separator of claim 1, wherein the coating layer comprises a surface coating formed on a surface of the inorganic compound by the organic/inorganic bindable silane compound.

3. The separator of claim 2, wherein the surface coating is continuous or discontinuous.

4. The separator of claim 1, wherein the organic/inorganic bindable silane compound having the reactive functional group is selected from the group consisting of epoxyalkylalkoxysilanes, aminoalkylalkoxysilanes, isocyanato alkylalkoxysilanes, mercapto alkylalkoxysilanes, and combinations thereof.

5. The separator of claim 1, wherein the organic/inorganic bindable silane compound having the reactive functional group is selected from the group consisting of vinylalkylalkoxysilanes, halogenated alkylalkoxysilanes, vinylhalosilanes, alkylacyloxysilanes, and combinations thereof, and wherein the vinylalkylalkoxysilanes, halogenated alkylalkoxysilanes, vinylhalosilanes, alkylacyloxysilanes, and combinations thereof comprise the reactive functional group selected from the group consisting of amino groups, isocyanate groups, epoxy groups, mercapto groups, and combinations thereof.

6. The separator of claim 1, wherein the inorganic compound is selected from the group consisting of SrTiO₃, SnO₂, CeO₂, MgO, NiO, CaO, ZnO, ZrO₂, Y₂O₃, Al₂O₃, TiO₂, BaTiO₃, SiO₂, and combinations thereof.

7. The separator of claim 1, wherein the coating layer of the separator further comprises a binder selected from the group consisting of polyvinylidenefluoride (PVdF), poly(vinylidene-hexafluoropropylene) (P(VdF-HFP)), a modified PVDF with COOH, polyethyleneoxide (PEO), polyacrylonitrile (PAN), polyimide (PI), polyamic acid (PAA), polyamideimide (PAI), aramid, polyvinylacetate (PVA), polymethylmethacrylate (PMMA), polyvinylether (PVE), and combinations thereof.

8. The separator of claim 1, wherein the separator further comprises a porous substrate selected from the group consisting of glass fiber, polyester, tetrafluoroethylene, polyolefin, polytetrafluoroethylene (PTFE), and combinations thereof.

9. The separator of claim 7, wherein the coating layer of the separator is formed on one side or both sides of the porous substrate.

10. The separator of claim 1, wherein the coating layer of the separator comprises about 1 part by weight to about 20 parts by weight of the organic/inorganic bindable silane compound having the reactive functional group, based on 100 parts by weight of the inorganic compound.

11. The separator of claim 6, wherein the coating layer of the separator comprises the inorganic compound and the binder in a weight ratio in a range of about 1:0.5 to about 1:5.

12. The separator of claim 1, wherein the organic/inorganic bindable silane compound having the reactive functional group is selected from the group consisting of 3-glycidoxypropyltrimethoxysilane, 3-glycidoxypropyltriethoxysilane, 2-(3,4-epoxycyclohexyl)ethyltrimethoxysilane, 3-glycidoxypropylmethyldiethoxysilane, (3-trimethoxysilylpropyl)diethylenetriamine, (2-aminoethyl)-3-aminopropyltrimethoxysilane, N-methylaminopropyltrimethoxysilane, 3-(triethoxysilyl)propyl isocyanate, 3-(trimethoxysilyl)propyl isocyanate, 3-mercaptopropyltrimethoxysilane, bis(3-(triethoxysilyl)propyl)-tetrasulfide, vinyltris (2-methoxy ethoxy) silane, 3-methacryloxylpropyltrimethoxysilane, 3-chloropropyltrimethoxysilane, vinyltrichlorosilane, methyltriacetoxysilane, and combinations thereof.

13. A rechargeable battery comprising:
a positive electrode;
a negative electrode; and
the separator of claim 1 between the positive electrode and the negative electrode.

14. The battery of claim 13, wherein the coating layer comprises a surface coating formed on a surface of the inorganic compound by the organic/inorganic bindable silane compound.

15. The battery of claim 13, wherein the organic/inorganic bindable silane compound having the reactive functional group is selected from the group consisting of epoxyalkylalkoxysilanes, aminoalkylalkoxysilanes, isocyanato alkylalkoxysilanes, mercapto alkylalkoxysilanes, and combinations thereof.

16. The battery of claim 13, wherein the organic/inorganic bindable silane compound having the reactive functional group is selected from the group consisting of vinylalkylalkoxysilanes, halogenated alkylalkoxysilanes, vinylhalosilanes, alkylacyloxysilanes, and combinations thereof, and wherein the vinylalkylalkoxysilanes, halogenated alkylalkoxysilanes, vinylhalosilanes, alkylacyloxysilanes, and combinations thereof comprise the reactive functional group selected from the group consisting of amino groups, isocyanate groups, epoxy groups, mercapto groups, and combinations thereof.

17. The battery of claim 13, wherein the inorganic compound is selected from the group consisting of SrTiO₃, SnO₂, CeO₂, MgO, NiO, CaO, ZnO, ZrO₂, Y₂O₃, Al₂O₃, TiO₂, BaTiO₃, SiO₂, and combinations thereof.

18. The battery of claim 13, wherein the coating layer of the separator comprises about 1 part by weight to about 20 parts by weight of the organic/inorganic bindable silane compound having the reactive functional group, based on 100 parts by weight of the inorganic compound.

19. The battery of claim 13, wherein the organic/inorganic bindable silane compound having the reactive functional group is selected from the group consisting of 3-glycidoxypropyltrimethoxysilane, 3-glycidoxypropyltriethoxysilane, 2-(3,4-epoxycyclohexyl)ethyltrimethoxysilane, 3-glycidoxypropylmethyldiethoxysilane, (3-trimethoxysilylpropyl)diethylenetriamine, (2-aminoethyl)-3-aminopropyltrimethoxysilane, N-methylaminopropyltrimethoxysilane, 3-(triethoxysilyl)propyl isocyanate, 3-(trimethoxysilyl)propyl isocyanate, 3-mercaptopropyltrimethoxysilane, bis(3-(triethoxysilyl)propyl)-tetrasulfide, vinyltris (2-methoxy ethoxy) silane, 3-methacryloxylpropyltrimethoxysilane, 3-chloropropyltrimethoxysilane, vinyltrichlorosilane, methyltriacetoxysilane, and combinations thereof.

20. The battery of claim 13, wherein the coating layer of the separator further comprises a binder, and wherein the coating layer of the separator comprises the inorganic compound and the binder in a weight ratio in a range of about 1:0.5 to about 1:5.

21. A method of forming a rechargeable battery, the method comprising:
forming the separator of claim 1, a positive electrode, and a negative electrode into an electrode assembly; and
providing an electrolyte to the electrode assembly.
